(19) United States
(12) Patent Application Publication
(10) Pub. No.: US 2006/0270475 A1
(43) Pub. Date: Nov. 30, 2006

(54) Card size electronic game device

(75) Inventor: Danny Chan, Kowloon (HK)

Correspondence Address: NORRIS, MCLAUGHLIN & MARCUS, P.A., 875 THIRD AVE, 18TH FLOOR, NEW YORK, NY, 10022, US

(73) Assignee: Dah Sun Calculator Manufacturing Co. Ltd., Kowloon (HK)

(21) Appl. No.: 11/190,461

(22) Filed: Jul. 27, 2005

(30) Foreign Application Priority Data
May 27, 2005 (CN) 200510074356.0

(51) Int. Cl. A63F 13/00

(52) U.S. Cl. 463/1

(57) ABSTRACT

The present invention provides a card size electronic game device, which comprises a printed circuit board on which a main chip is provided; wherein the printed circuit board is further provided with one or more storage devices which are connected with input/output interfaces of the main chip and can be read and written repeatedly, and one or more input/output interfaces for connecting a programming means; the game chip receives a game program preprogrammed by the programming means through said one or more input/output interfaces, and then said game program is inputted to and stored in said one or more storage devices via the input/output interfaces of the main chip. The card size electronic game device can not only be programmed independently and freely, but also have better security and lower cost.

### FIELD OF THE INVENTION

The invention relates to an electronic game device, in particular to a card size electronic game device.

### BACKGROUND ART

Presently, the game devices on the market may be substantially classified into the following two kinds. One is the conventional game cards made of printed papers; the other is the electronic game device. In the electronic game devices, the card size electronic game device is more popular. For example, US 2004/0235550A1 and WO 03/008057 disclose a card-like electronic game device, in which the game mode is: several random characters generated by a random number generator are displayed in a first window group while the characters selected by a player are displayed in a second window group; if any of the characters displayed in the first window group matches a character displayed in the corresponding window of the second window group, this will be classed as a win. Such card-like electronic game device comprises a microprocessor chip which is required to be programmed before the assembly of the electronic game device so as to determine the winning, the non-winning, the winning order and the like of each game. Accordingly, before such card-like electronic game devices are mass-produced, the preprogrammed operation programs with the winning, the non-winning, the winning order and the like must be ordered previously in batch and then written into the chip by specific machine. Once these programs are written into the chip, they cannot be changed. That is, the game programs about the winning, the non-winning, the winning order and the like of each game are unchangeable. If the manufacturer needs to change the contents of the game programs, it is necessary for him to additionally order a batch of chips with new programs. Thus, such electronic game device lacks of flexibility, so that there is a certain limitation on the production and sale and the cost is higher. In addition, in order to determine the winning, the non-winning or the assignation of various winning levels in such electronic game device, it is generally required to connect one of the contacts prearranged on the specific chip with preprogrammed operation programs to an interface of another appointed printed circuit board by manual work. Obviously, there are some manmade mistakes during the manufacture process of the electronic game device; moreover, the degree of secrecy in the manufacture process is so low that more than one style of electronic game devices can be discretionarily produced at any moment, thereby the security of the market of the electronic game will be subject to unexpected destroy.

Therefore, there is a need of a card size electronic game device which can not only be programmed independently and freely, but also have better security, higher flexibility, simpler structure and lower cost.

### SUMMARY OF THE INVENTION

An object of the invention is to provide a card size electronic game device, which can not only be programmed independently and freely, but also have better security, higher flexibility, simpler structure and lower cost, so as to overcome the disadvantages in the prior art.

In order to achieve the above object, the present invention provides a card size electronic game device, which comprises:

a printed circuit board on which a main chip is provided;

wherein the printed circuit board is further provided with one or more storage devices which are connected with input/output interfaces of the main chip and can be read and written repeatedly, and one or more input/output interfaces for connecting a programming means; the main chip receives a game program preprogrammed by the programming means through said one or more input/output interfaces, and then said game program is inputted to and stored in said one or more storage devices via the input/output interfaces of the main chip.

According to the foregoing card size electronic game device, a database of the graphs, characters and numbers to be shown on a display of the card size electronic game device, a driving program for driving the display and a program about input buttons of the card size electronic game device are previously written in the main chip.

According to the foregoing card size electronic game device, the display can show said graphs, characters, numbers and the combination thereof optionally and randomly.

According to the foregoing card size electronic game device, the card size electronic game device further comprises a sound effect generating element which is electrically connected with the main chip.

According to the foregoing card size electronic game device, the printed circuit board is further provided with one or more programmable sound effect generating output interfaces through which the sound effect generating element is electrically connected with the main chip.

According to the foregoing card size electronic game device, one or more sound effect generating programs with different audio frequencies and tones are also written in the main chip.

According to the foregoing card size electronic game device, the card size electronic game device further comprises a thin-film input button unit provided with button contacts; and the button contacts are electrically connected with button wiring blocks on the printed circuit board which are electrically connected with the main chip.

According to the foregoing card size electronic game device, said one or more storage devices are storage chips capable of being read and written repeatedly.

According to the foregoing card size electronic game device, the storage means is a personal computer.

Compared with the prior art, the card size electronic game device of the present invention have the technical effects as follows:

1) By using the personal computer, the game program may be inputted into the main chip through the input/output interface(s), and then transmitted to the storage device(s) capable of being repeatedly read and written and stored therein. Thereby, the manufacturer can freely and separately program and then input a new program into the storage device(s) of the electronic game device, without the need of reordering a large batch of main chips because of changing the contents in the game device. Therefore, the manufacturer may update the program in the electronic game device at any time as required so that the electronic game device is more easily manufactured with lower cost, higher flexibility and simpler structure.

2) More importantly, since the card size electronic game device can directly transmit the game program preprogrammed by a outer computer into the storage chip(s) of the card size electronic game device, all of the manufacture processes can be controlled by a computer, without the need of manually connecting one of the contacts prearranged on a new chip to another appointed interface on the printed circuit board because of changing the contents in the game device. Thereby, the card size electronic game device of the present invention can avoid the manual errors or cheats and have better security.

### BRIEF DESCRIPTION OF THE DRAWINGS

FIG. 1A is a front view of a card size electronic game device according to an embodiment of the present invention;

FIG. 1B is a side view of the card size electronic game device shown in FIG. 1A;

FIG. 1C is a rear view of the card size electronic game device shown in FIG. 1A;

FIG. 2 is an exploded perspective view of the card size electronic game device shown in FIG. 1A;

FIG. 3 is a block diagram showing the connection relationships of the main components of the card size electronic game device shown in FIG. 2; and

FIG. 4 is a schematic view of the distribution of components on a printed circuit board connected with a display.

### PREFERRED EMBODIMENTS OF THE INVENTION

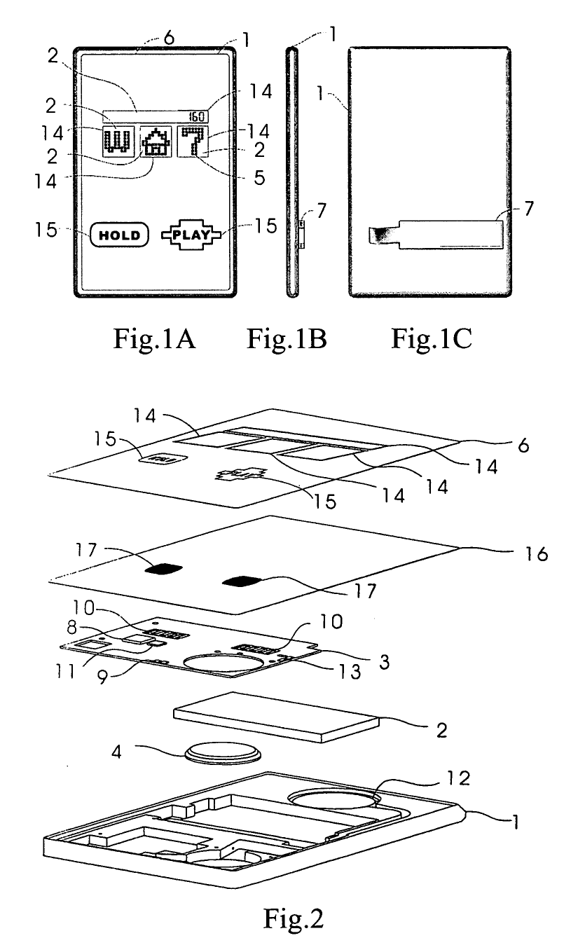

Hereinafter, an embodiment of the card size electronic game device of the present invention will be described in detail with reference to FIG. 1A to FIG. 4. Since the game mode and game course of the card size electronic game device are similar to those in the prior art, the related description is omitted. The present invention is directed to the improvement of the design, manufacture and function of the card size electronic game device in the prior art. Herein, the inner electronic components of the card size electronic game device and the connection relationships and functions thereof will be described in detail in conjunction with the embodiment.

Please refer to FIG. 1A to FIG. 1C and FIG. 2 firstly. FIG. 1A to FIG. 1C are a front view, a side view and a rear view of a card size electronic game device according to an embodiment of the present invention respectively. FIG. 2 is an exploded perspective view of the card size electronic game device shown in FIG. 1A. The card size electronic game device comprises a housing 1, for example with a rectangular shape, a color printed panel 6 provided on the housing 1, and a thin-film input button unit 16, a printed circuit board 3, displays 2, a battery 4, a sound effect generating element 12 and the like which are located between the housing 1 and the color printed panel 6. A battery protection element 7 is provided on the back of the housing 1.

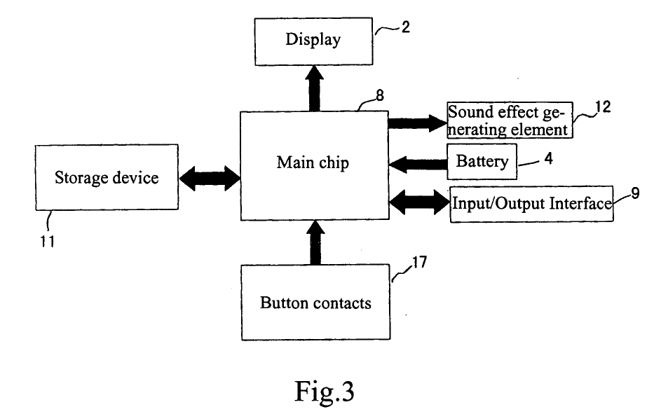

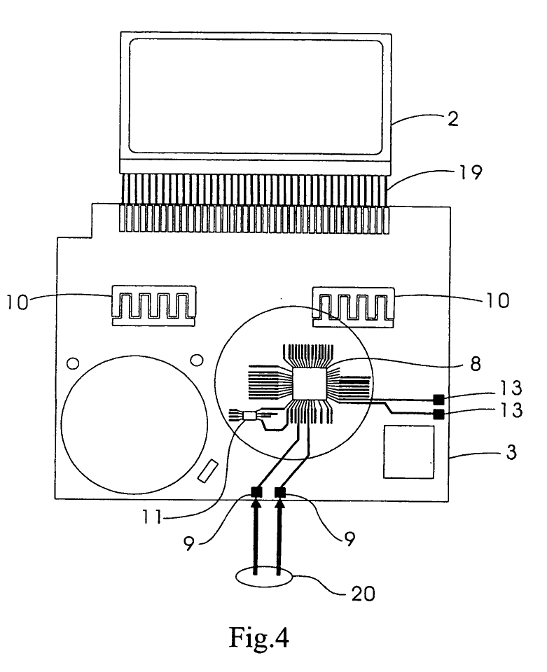

The color printed panel 6 may be attached to the thin-film input button unit 16 with the adhesive on the back thereof, and the thin-film input button unit 16 may be attached to the housing 1 with the adhesive on the back thereof. A plurality of display windows 14 (there are four display windows in this embodiment) corresponding to the displays 2 and a plurality of buttons 15 (there are two buttons in this embodiment: for example one is “hold” button for locking the game process, and the other is “play” button for starting the game process) are provided on the color printed panel 6. Two button contacts 17 corresponding to and electrically connected with the two buttons 15 are provided on the thin-film input button unit 16. The printed circuit board 3 is provided thereon with a main chip 8, one or more input/output interfaces 9 (there are two input/output interfaces in this embodiment), an end of which is electrically connected with the main chip 8, and the other end of which is electrically connected with a programming means 20 (e.g. computer or the like) capable of programming game programs; two button wiring blocks 10, which are electrically connected with each of two button contacts 17 respectively; one or more storage devices 11 (there is only one storage device in this embodiment) for storing the game program containing the data and operation program, which are electrically connected with the main chip 8; and one or more sound effect output interfaces 13 (there are two sound effect output interfaces in this embodiment), an end of which is electrically connected with the sound effect generating element 12, and the other end of which is electrically connected with the main chip 8, i.e. the sound effect generating element 1.2 is electrically connected with the main chip 8 through the sound effect output interface 13 (please refer to FIG. 3). Referring to FIG. 3 and FIG. 4, the display 2 is electrically connected with the main chip 8 through connection wires 19, so that the patterns, words, numbers and the combination thereof can be displayed optionally and randomly, thus the player can clearly see the results of the winning, the non-winning and other combinations through the display windows 14 on the color printed panel 6. The battery 4 is electrically connected with the main chip 8 to supply the necessary electric power to the main chip 8.

Please refer to FIG. 3 and FIG. 4, wherein FIG. 3 is a block diagram showing the connection relationships of the main components of the card size electronic game device shown in FIG. 2; and FIG. 4 is a schematic view of the distribution of components on a printed circuit board connected with a display. The main chip 8 includes a plurality of input/output interfaces, some of which are suitable for connecting outer electronic components (e.g. storage device(s) 11). The main chip 8 may program one or more input/output interfaces (there are two input/output interfaces in this embodiment) thereof and make them electrically connect with the storage device(s) 11; at the same time, the main chip 8 may program one or more other input/output interfaces (there are two input/output interfaces in this embodiment) thereof and make them electrically connect with the input/output interface(s) 9 provided on the printed circuit board 3. The storage device(s) 11 may be repeatedly read and written, for example as the electronic storage chip(s) capable of being repeatedly read and written.

The standard programs are previously written into the main chip 8, such as the database with the graphics, words and numbers to be shown in the display; a driving program for driving the display; and a program about the buttons. In addition, one or more sound effect generating programs with different audio frequencies and tones may also be written into the main chip 8, so that the sound effect generating element 12 connected with the sound effect output interface(s) 13 can produce euphonic sound effects in order to enhance the interest and attractability of the card size electronic game device.

When the manufacturer needs to change the operation programs about the winning, the non-winning, the winning order and the like of a game in the card size electronic game device, the following procedures may be employed: programming by a personal computer (or a means with the same programming function), inputting the programmed operation program about the winning, the non-winning, the winning order and the like into the main chip 8 through the input/output interface(s) 9, receiving the operation program through the corresponding input/output interface(s) of the main chip 8, processing the operation program and then transmitting the operation program into the storage device(s) 11 through the corresponding input/output interface(s) to store the operation program therein. By repeating the above procedures, the manufacturer may change the operation program as many times as required. As to the above procedures performed by the main chip 8, it is easy for the technicians in this art to put them into practice in the form of software according to the contents about the above mentioned procedures.

Accordingly, compared with the prior art, the card size electronic game device of the present invention have the technical effects as follows:

1) By using the personal computer or the means with the same programming function, the game program (such as the operation program about the winning, the non-winning and the winning order) may be inputted into the main chip 8 through the input/output interface(s) 9 and then transmitted to an electronic storage chip capable of being repeatedly read and written (i.e. the storage device(s) 11) and stored therein. Thereby, the manufacturer can freely and independently program and then input a new program into the storage device(s) 11 of the electronic game device, without the need of reordering a large batch of main chips because of changing the contents in the game device. Therefore, the manufacturer may update the program in the electronic game device at any time as required so that the electronic game device is more easily manufactured with lower cost, higher flexibility and simpler structure.

2) More importantly, since the card size electronic game device can directly transmit the game program programmed by an outer personal computer or the means with the same programming function into the storage chips (i.e. the storage device(s) 11) of the card size electronic game device, all of the manufacture processes can be controlled by a computer or the like, without the need of manually connecting one of the contacts previously arranged on a new chip to another appointed interface on the printed circuit board because of changing the contents in the game device. Thereby, the card size electronic game device of the present invention can avoid the manual errors or cheats and have better security.

What is claimed is:

1. A card size electronic game device, which comprises:
a printed circuit board (3) on which a main chip (8) is provided;
wherein, the printed circuit board (3) is further provided with one or more storage devices (11) which are connected with input/output interfaces of the main chip (8) and can be read and written repeatedly, and one or more input/output interfaces (9) for connecting a programming means (20); the main chip (8) receives a game program preprogrammed by the programming means (20) through said one or more input/output interfaces (9), and then said game program is inputted to and stored in said one or more storage devices (11) via the input/output interfaces of the main chip (8).

2. A card size electronic game device according to claim 1, wherein a database of the graphs, characters and numbers to be shown on a display (2) of the card size electronic game device, a driving program for driving the display (2) and a program about input buttons (15) of the card size electronic game device are previously written in the main chip (8).

3. A card size electronic game device according to claim 2, wherein the display (2) can show said graphs, characters, numbers and the combination thereof optionally and randomly.

4. A card size electronic game device according to claim 1, wherein the card size electronic game device further comprises a sound effect generating element (12) which is electrically connected with the main chip (8).

5. A card size electronic game device according to claim 4, wherein the printed circuit board (3) is further provided with one or more programmable sound effect generating output interfaces (13) through which the sound effect generating element (12) is electrically connected with the main chip (8).

6. A card size electronic game device according to claim 1, wherein one or more sound effect generating programs with different audio frequencies and tones are also written in the main chip (8).

7. A card size electronic game device according to claim 1, wherein the card size electronic game device further comprises a thin-film input button unit (16) provided with button contacts (17); and the button contacts (17) are electrically connected with button wiring blocks (10) on the printed circuit board (3) which are electrically connected with the main chip (8).

8. A card size electronic game device according to claim 1, wherein said one or more storage means (11) are storage chips capable of being read and written repeatedly.

9. A card size electronic game device according to claim 1, wherein the programming means (20) is a personal computer.
